(19) United States
(12) Patent Application Publication
(10) Pub. No.: US 2018/0120588 A1
(43) Pub. Date: May 3, 2018

(54) Eyeglasses with Clip Member for Use with a Frame And At least One Temple Member

(71) Applicant: Ronese Brooks, Yonkers, NY (US)

(72) Inventor: Ronese Brooks, Yonkers, NY (US)

(21) Appl. No.: 15/796,277

(22) Filed: Oct. 27, 2017

Related U.S. Application Data
(60) Provisional application No. 62/414,694, filed on Oct. 29, 2016.

(51) Int. Cl. G02C 5/14

(52) U.S. Cl. CPC G02C 5/146; G02C 2200/08

(57) ABSTRACT

Eyeglasses with clip member for use with a frame and at least one temple member extending therefrom structured and arranged to secure removable temples to an orbital frame of eyeglasses to provide consumers with a simple and affordable way in which to replace broken or missing eyeglass temples, temporarily or long term.

### CROSS-REFERENCE TO RELATED APPLICATION

The present application is related to and claims priority from prior provisional application Ser. No. 62/414,694, filed Oct. 29, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of accessory devices and more specifically relates to eyeglasses with clip member for use with a frame and at least one temple member extending therefrom structured and arranged to secure removable temples to an orbital frame of eyeglasses to provide consumers with a simple and affordable way in which to replace broken or missing eyeglass temples, temporarily or long term.

### 2. Description of the Related Art

Every day, an astonishing number of Americans depend on corrective lenses to help them see well enough to complete their daily tasks. To improve their vision, these consumers are prescribed corrective eyewear, from practically invisible contact lenses to the more common external eyeglasses. In addition, many sight challenged individuals are very sensitive to bright sunlight, and use darkened, light-filtering sunglasses as a protective measure. Not limited to those with vision problems, sunglasses are quite ubiquitous. Whether as a means of blocking the sun or to express a fashion statement, sunglasses serve both a practical and aesthetic purpose for both the visually impaired and those with perfect sight.

While prescription glasses are necessary and sunglasses are convenient, use of these protective lenses is not without a drawback. Particularly, the temples of the eyewear are easily susceptible to damage. The temples (also known as eyeglasses arms) are parts that secure the frame front and keep the glasses on the ears. As can be imagined, these thin supports are often broken as wearers navigate the demands of on-the-go living. Since the glasses cannot be worn without the temples intact, consumers have no choice but to visit their eye doctor or an eyewear store and hope that the glasses can be fixed. Not only is this endeavor time-consuming, but it can prove quite costly as well.

Various attempts have been made to solve the above-mentioned problems such as those found in: U.S. Pat. No. 5,321,442 to Gerry M. Albanese; U.S. Patent No. 20120050663 to Suzanne Huston; and U.S. Pat. No. 4,564,272 to Edmond A. Rinnooy Kan. This art is representative of eyeglasses with interchangeable parts. None of the above inventions and patents, taken either singly or in combination, is seen to describe the invention as claimed.

Ideally, eyeglasses with clip member for use with a frame and at least one temple member extending therefrom should be user-friendly and safe in-use and, yet should operate reliably and be manufactured at a modest expense. Thus, a need exists for eyeglasses with clip member for use with a frame and at least one temple member extending therefrom structured and arranged to secure removable temples to an orbital frame of eyeglasses to provide consumers with a simple and affordable way in which to replace broken or missing eyeglass temples, temporarily or long term and to avoid the above-mentioned problems.

### BRIEF SUMMARY OF THE INVENTION

In view of the foregoing disadvantages inherent in the known accessory device art, the present invention provides eyeglasses with clip member for use with a frame and at least one temple member extending therefrom (Entitled Eyeglasses with Clip Member for use with a Frame and at least One Temple Member). The general purpose of the present invention, which will be described subsequently in greater detail is to provide eyeglasses with clip member for use with a frame and at least one temple member extending therefrom structured and arranged to secure removable temples to an orbital frame of eyeglasses to provide consumers with a simple and affordable way in which to replace broken or missing eyeglass temples, temporarily or long term.

Eyeglasses with clip member for use with a frame and at least one temple member extending therefrom, the clip member comprising: an attachment member including an attachment portion and a pair of arm members; a holding member including a top portion and a bottom portion; and an adjustable connector member. The attachment portion is adapted to be slidably attached into the slot on the frame of the eyeglasses. The pair of arm members are connected to and extend from the attachment portion. Wherein the pair of arm members are spaced from one another forming a holding space there between adapted to releasably retain a holding member therein.

The top portion includes an elongated back member and an elongated top member. The elongated top member is attached to and extends perpendicularly from the elongated back member. The bottom portion includes an elongated back member and an elongated bottom member. The elongated bottom member is attached to and extends perpendicularly from the elongated back member.

The adjustable connector member is adjustably connected between the top portion and the bottom portion, such that the top member of the top portion and the bottom member of the bottom portion extend parallel to one another and in the same direction, and such that the distance between the top member and the bottom member can be adjusted and adapted to releasably hold a temple member there between.

Wherein the attachment member is adapted to be slidably attached into the slot on the frame of the eyeglasses, the holding member is adapted to be releasably attached to an attachment end of an eyeglass temple member, and wherein the holding member is adapted to be releasably attached to the attachment member to thereby releasably connect a temple member to a frame of the eyeglasses.

An improved eyeglass system is also disclosed comprising: a pair of eyeglasses and a pair of clip members. The pair eyeglasses including: a frame and a pair of temple members. The frame includes a right side frame portion and a left side frame portion. The pair of temple members each include a distal end and an attachment end. Wherein the attachment end is adapted to be connected to one of the right or left side portions of the frame.

The present invention holds significant improvements and serves as eyeglasses with clip member for use with a frame and at least one temple member extending therefrom. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, eyeglasses with clip member for use with a frame and at least one temple member extending therefrom (Entitled Eyeglasses with Clip Member for use with a Frame and at least One Temple Member), constructed and operative according to the teachings of the present invention.

FIG. 1 shows a perspective view illustrating a clip member having an attachment member, a holding member for use with eyeglasses having a frame and at least one temple member extending therefrom according to an embodiment of the present invention.

FIG. 2 is another perspective view illustrating the holding members in various sizes of the clip member according to an embodiment of the present invention.

FIG. 3 is a perspective view illustrating an improved eyeglass system according to an embodiment of the present invention of FIG. 1.

FIG. 4 is a perspective view illustrating the improved eyeglass system in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to an accessory device and more specifically relates to Eyeglasses with Clip Member for use with a Frame and at least One Temple Member extending therefrom structured and arranged to secure removable temples to an orbital frame of eyeglasses to provide consumers with a simple and affordable way in which to replace broken or missing eyeglass temples, temporarily or long term.

Generally speaking, the Eyeglasses with Clip Member for use with a Frame and at least One Temple Member, allow users be able to easily and expediently repair broken temples in a matter of seconds. A universal, expandable, rotatable, and adjustable device, the snap-clip would be fashioned of a durable plastic or metal material and would be offered in small, medium, and large sizes. The adjustable and expandable feature of the snap-clip would also allow it to fit practically any size temple. This snap-clip could be placed on any portion (upper, middle, or lower) of the peripheral orbit of the eyeglasses frame.

Additionally, the rotation feature of the snap-clip would allow the temples to be folded securely away between wearing. Said temples provided with the eyeglasses frame, which would snap into the clips, would also be made of plastic or metal, and would measure approximately 120 mm to 150 mm in length. Like standard temples, these replacement units could be sheathed in a rubberized material so that they are comfortable when placed on the ears. The replacement/removable temples would be made available in a variety of colors and styles, and could be bedazzled and bejeweled as well, to appeal to a variety of individual tastes. As such, the replacement/removable temples might also be interchangeably used simply to change things up and add some flare, or to coordinate with an outfit or overall look.

A highly versatile product, Eyeglasses with Clip Member for use with a Frame and at least One Temple Member would provide prescription lens, reading, and sunglasses wearers with a convenient and effective means of keeping their eyewear in working order at all times. Universal snap-clips that readily accept replacement and removable temples would facilitate instant repair in the event existing temples are broken or damaged. As a result, users need not worry that they will have to take precious time out of hectic and busy days to get their eyeglasses repaired. Moreover, Eyeglasses with Clip Member for use with a Frame and at least One Temple Member would eliminate the need to waste money on costly replacement parts or a new pair of eyeglasses. And, the clever snap-clip configuration would blend seamlessly with existing orbital frames.

Attractive as well as practical, the colors and styles offered in this line would make this product a fashionable accessory for any look, whether professional or casual. Sunglasses wearers will also appreciate that this product provides a means of keeping expensive shades fully functional at all times, especially in a pinch. Convenient and simple, the Eyeglasses with Clip Member for use with a Frame and at least One Temple Member should be well received by the vast majority of consumers who depend on external eyewear, a colossal market potential.

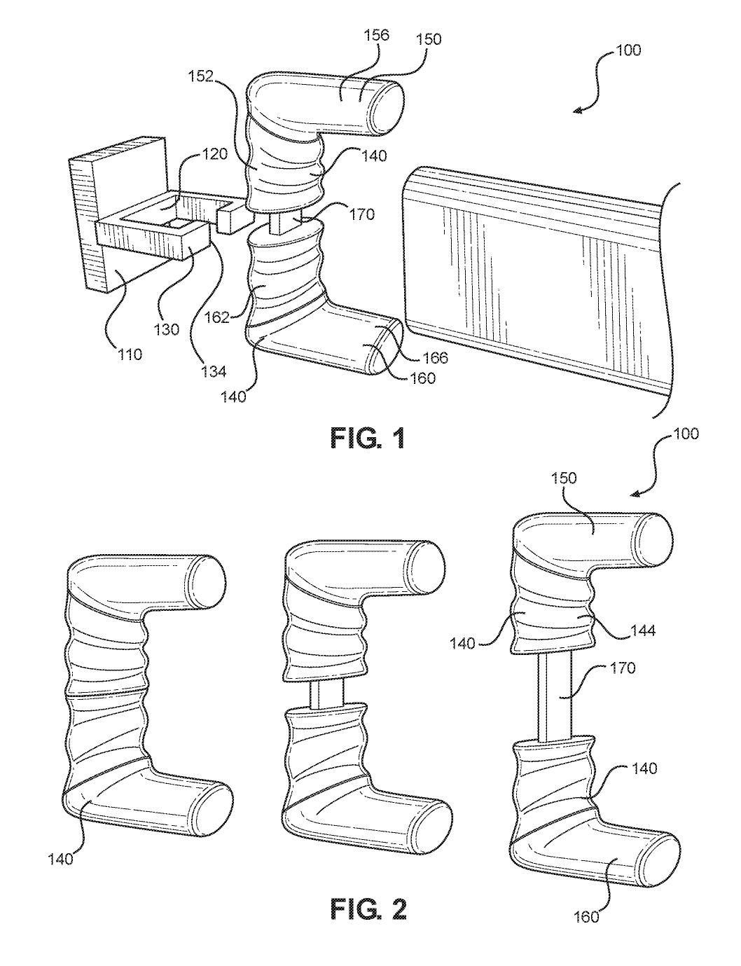

Referring now to FIGS. 1 & 2, showing perspective views clip member 100 for use with a frame 320 with slot 324 and at least one temple member 350 extending therefrom, according to an embodiment of the present invention of FIG. 1

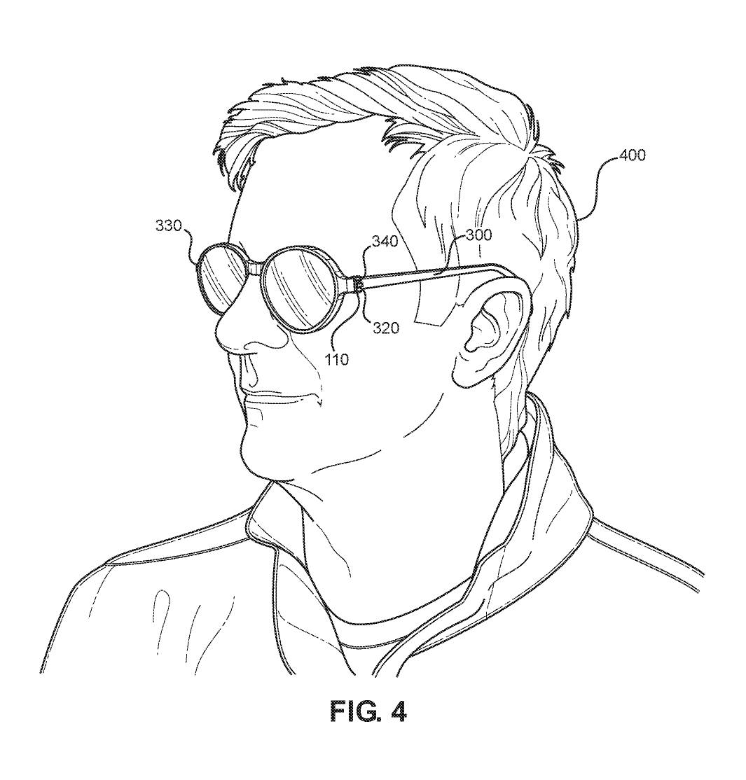

Eyeglasses 310 with a clip member 100 for use with a frame 320 and at least one temple member 350 extending therefrom, clip member 100 comprising: attachment member 110 and holding member 140. Attachment member 110 includes attachment portion 120 and pair of arm members 130; holding member 140 including top portion 150 and bottom portion 160; and adjustable connector member 170. Attachment portion 120 is adapted to be slidably secured to the slot 324 on the frame 320 of eyeglasses 350 as shown in in-use condition 400 of FIG. 4. Pair of arm members 130 are connected to and extend from attachment portion 120. Wherein pair of arm members 130 are spaced from one another forming holding space 134 there between adapted to releasably retain holding member 140 therein. Pair of arm members 130 of attachment member 110 are formed from a flexible material adapted to allow holding member 140 to be snapped in and out of place there between.

Top portion 150 includes elongated back member 152 and elongated top member 156. Elongated top member 156 is attached to and extends perpendicularly from elongated back member 152. Bottom portion 160 includes elongated back member 162 and elongated bottom member 166. Elongated bottom member 160 is attached to and extends perpendicularly from elongated back member 162. Elongated back member 152 of top portion 150 and elongated back member 162 of bottom portion 160 of holding member 140 are formed having an undulated surface forming series of notches 144 along a length thereof. Wherein pair of arm members 130 of attachment member 110 are adapted to releasably retain holding member 140 in various positions via pair of arm members 130 and series of notches 144.

Adjustable connector member 170 is adjustably connected between top portion 150 and bottom portion 160, such that top member 156 of top portion 150 and bottom member 166 of bottom portion 160 extend parallel to one another and in the same direction, and such that the distance between top member 156 and bottom member 166 can be adjusted and adapted to releasably hold temple member 350 therebetween.

Wherein attachment member 110 is adapted to be slidably attached to slot 324 on frame 320 of eyeglasses 310, holding member 140 is adapted to be releasably attached to attachment end 370 of eyeglass temple member 350, and wherein holding member 140 is adapted to be releasably attached to attachment member 110 to thereby releasably connect temple member 350 to frame 320 of eyeglasses 310.

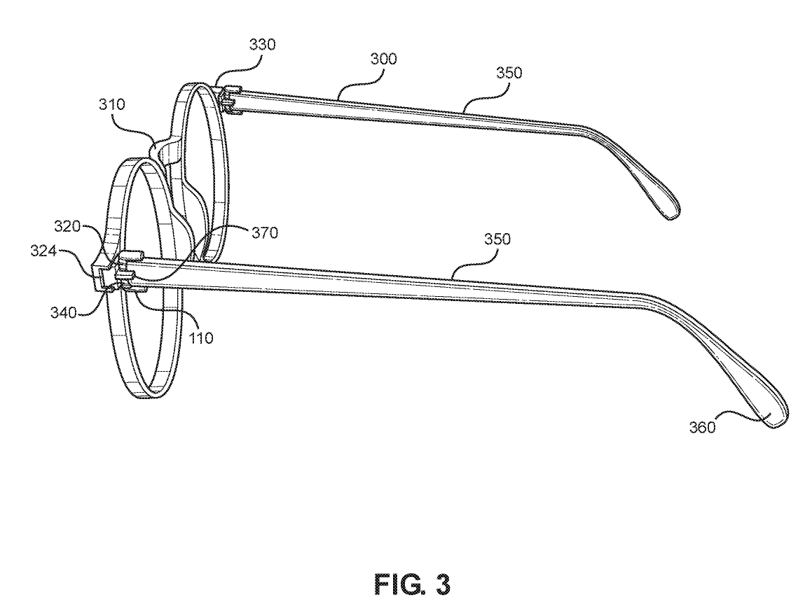

Referring now to FIGS. 3 & 4, showing perspective views illustrating improved eyeglass system 300 according to an embodiment of the present invention of FIG. 1.

Improved eyeglass system 300 is also disclosed comprising: pair eyeglasses 310 and pair of clip members 100. Pair eyeglasses 310 includes: frame 320 and pair of temple members 350. Frame 320 includes a right side frame portion 330 and left side frame portion 340. Frame 320 may be formed from a plastic material or from a metallic material.

Pair of temple members 350 each include distal end 360 and attachment end 370. Pair of temple members 350 are formed having a length between 120 millimeters and 150 millimeters. Pair of temple members 350 may be formed from a plastic material or from a metallic material. Wherein attachment end 370 is adapted to be connected to slot 324 on right or left side portions of frame 310 as shown in FIG. 3.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A clip member for use with eyeglasses having a frame and at least one temple member extending therefrom, said clip member comprising:
an attachment member including:
an attachment portion;
wherein said attachment portion is adapted to be slidably attached to said frame of said eyeglasses; and
a pair of arm members;
wherein said pair of arm members are connected to and extend from said attachment portion; and
wherein said pair of arm members are spaced from one another forming a holding space therebetween adapted to releasably retain a holding member therein; and
a holding member including:
a top portion including:
an elongated back member; and
an elongated top member;
wherein said elongated top member is attached to and extends perpendicularly from said elongated back member;
a bottom portion including:
an elongated back member; and
an elongated bottom member;
wherein said elongated bottom member is attached to and extends perpendicularly from said elongated back member; and
an adjustable connector member;
wherein said adjustable connector member is adjustably connected between said top portion and said bottom portion, such that said top member of said top portion and said bottom member of said bottom portion extend parallel to one another and in the same direction, and such that the distance between said top member and said bottom member can be adjusted and adapted to releasably hold a temple member therebetween;
wherein said attachment member is adapted to be slidably attached to said frame of said eyeglasses, said holding member is adapted to be releasably attached to an attachment end of an eyeglass temple member, and wherein said holding member is adapted to be releasably attached to said attachment member to thereby releasably connect a temple member to a frame of said eyeglasses.

2. The clip member of claim 1, wherein said elongated back members of said top and bottom portions of said holding member are formed having an undulated surface forming a series of notches along a length thereof; and wherein said pair of arm members of said attachment member are adapted to releasably retain said holding member in various positions via said pair of arm members and said series of notches.

3. The clip member of claim 1, wherein said pair of arm members of said attachment member are formed from a flexible material adapted to allow said holding member to be snapped in and out of place there between.

4. An improved eyeglass system comprising:
a pair eyeglasses including:
a frame including:
a right side frame portion;
a left side frame portion; and
a pair of temple members each including:
a distal end; and
an attachment end;
wherein said attachment end is adapted to be connected to one of said right or left side portions of said frame; and
a pair of clip members each comprising:
an attachment member including:
an attachment portion;
wherein said attachment portion is adapted to be slidably attached to a respective one of said right or left side portions of said frame of said pair of eyeglasses; and
a pair of arm members;
wherein said pair of arm members are connected to and extend from said attachment portion; and
wherein said pair of arm members are spaced from one another forming a holding space therebetween adapted to releasably retain a holding member therein; and
a holding member including:
a top portion including:
an elongated back member; and
an elongated top member;
wherein said elongated top member is attached to and extends perpendicularly from said elongated back member;
a bottom portion including:
an elongated back member; and
an elongated bottom member;
wherein said elongated bottom member is attached to and extends perpendicularly from said elongated back member; and
an adjustable connector member;
wherein said adjustable connector member is adjustably connected between said top portion and said bottom portion, such that said top member of said top portion and said bottom member of said bottom portion extend parallel to one another and in the same direction, and such that the distance between said top member and said bottom member can be adjusted and adapted to releasably hold a respective said temple member therebetween;
wherein each said attachment member is adapted to be slidably attached to a respective one of said right or left side portions of said frame of said pair of eyeglasses, each said holding member is adapted to be releasably attached to a respective attachment end of each said pair of temple members, and wherein said holding members are adapted to be releasably attached to respective said attachment members to thereby releasably connect said pair of temple members to said frame of of said pair of eyeglasses.

5. The improved eyeglass system of claim 4, wherein said elongated back members of said top and bottom portions of said holding member are formed having an undulated surface forming a series of notches along a length thereof; and wherein said pair of arm members of said attachment member are adapted to releasably retain said holding member in various positions via said pair of arm members and said series of notches.

6. The improved eyeglass system of claim 4, wherein said pair of arm members of said attachment member are formed from a flexible material adapted to allow said holding member to be snapped in and out of place therebetween.

7. The improved eyeglass system of claim 4, wherein said pair of temple members are formed having a length between 120 millimeters and 150 millimeters.

8. The improved eyeglass system of claim 4, wherein said pair of temple members are formed from a plastic material.

9. The improved eyeglass system of claim 4, wherein said pair of temple members are formed from a metallic material.

10. The improved eyeglass system of claim 4, wherein said frame is formed from a plastic material.

11. The improved eyeglass system of claim 4, wherein said frame is formed from a metallic material.

12. The improved eyeglass system of claim 4 wherein said frame further comprises at least one slot to allow for said pair of clip members and attachment members to slide onto said frame.
